(19) United States
(12) Patent Application Publication
(10) Pub. No.: US 2005/0055180 A1
(43) Pub. Date: Mar. 10, 2005

(54) Method and system for seat placement

(76) Inventors: Gina C. Pischke, Lynnwood, WA (US); Terry L. Wagstaff, Marysville, WA (US); Pheng S. Lim, Bothell, WA (US)

Correspondence Address: BLACK LOWE & GRAHAM PLLC, 701 FIFTH AVENUE, SUITE 4800, SEATTLE, WA, 98104, US

(21) Appl. No.: 10/657,553

(22) Filed: Sep. 8, 2003

(51) Int. Cl. G06F 17/50

(52) U.S. Cl. 703/1

(57) ABSTRACT

A method for generating three-dimension models and extracting data therefrom are provided. According to an exemplary embodiment of the present invention, a layout for interior configuration is received and critical dimensions are extracted from the interior configuration for the placement of seats. Seat dimensions for each of the several seat part numbers augment the extracted critical dimensions from the interior configurations. Assignment of part numbers to an appropriate location within the configuration enables generation of a three-dimensional solid model for testing in accord with known rules defining interference. Additionally, a seat installation drawing for direction to seat installers is generated, cable lengths for wiring runs are calculated, and a load analysis for the seat configuration is generated demonstrating FAR compliance.

### FIELD OF THE INVENTION

This invention relates generally to computer assisted modeling and, more specifically, to computer assisted modeling of aircraft.

### BACKGROUND OF THE INVENTION

When an airline customer orders a commercial aircraft from a manufacturer, many details are generally customized for the ordering customer. These details include the layout of the passenger compartment. Generally known as the “layout of personnel accommodations” (“LOPA”), the placement of seats, bulkheads, galleys, and lavatories vary from customer to customer in accord with the customer's corporate identity. One customer or commercial carrier may choose to emphasize the amount of leg room offered in coach class while another may choose to add a row of seats and gain efficiencies in terms of numbers of passengers per flight.

The LOPA is part of the order and is generally accommodated by the manufacturer. The customer or commercial carrier will designate a seat manufacturer and model line. The LOPA accompanying the order is drawn to precise dimensions and includes locations of various seats throughout the cabin. Thus, the LOPA becomes a part of the contract specification, requiring fulfillment in order to complete the order. Generally, the LOPA is provided to the manufacturer in the form of a plan view drawing, either in paper or in electronic form. Alternatively, the LOPA could exist as a database filled with numbers descriptive of precise seat anchoring locations and the seat parts anchored thereto. By either means, the customer's desires as to the precise seat placement are communicated to the manufacturer with the intent that the manufacturer build out the passenger cabin appropriately.

While the manufacturer may designate a seat and location, the manufacturer generally has not had the opportunity to build out the cabin in accord with the LOPA specification. Occasionally, it is the case that the seats, if placed as specified in the LOPA, will either interfere with the walls of the interior of the cabin hall or with other interior items.

In the past, the process of fitting the seats to the space has been achieved by producing a mockup of the space and testing the movement of each of the seats through its full range to check for interferences. When a mockup is not produced, the first construction of the first model of the order is done with special attention to interferences resulting from seat placement. In either regard, the process is costly and time consuming. Where an interference is noted, different seats must be tested in place in order to solve the interference problem. Even with the cooperation from the seat manufacturer, this can be an expensive process.

Aircraft manufacturers have obviated the need for mockups in other steps in the production method. Modeling aircraft in three-dimensional space on advanced computers has become a commonplace method for visualizing part placement. Three-dimensional models, where they can be practically generated, can save the manufacturer much of the expense attendant to full-size mockup.

Generating three-dimension models of single seats and replicating them throughout the space with the precise placement necessary to test for interference has been prohibitively expensive for single orders of aircraft. There exists then, an unmet need in the art for an inexpensive and accurate way to test seating placement for possible interferences in the environment of a passenger cabin.

### SUMMARY OF THE INVENTION

A method and system for generating three-dimension models and utilizing data therefrom is provided. Embodiments of the present invention eliminate the costly and repetitive engineering efforts entailed in generating a three-dimension model of seat placement within a defined passenger cabin. Likewise, embodiments of the invention obviate the need for constructing a mockup of the passenger cabin for interference testing. Installers can confidently install seats according to the generated seat installation drawing knowing that the placements have been tested for interferences.

As a result, embodiments of the invention allow a high-degree of competence in seat placement without requiring extensive engineering or material experience. According to a presently preferred embodiment, a layout for interior configuration is received and critical dimensions are extracted from the interior configuration for the placement of seats. Seat dimensions for each of the several seat part numbers augment the extracted critical dimensions from the interior configurations. Assignment of part numbers to an appropriate location within the configuration enables generation of a three-dimensional solid model for testing in accord with known rules defining interference. Additionally, a seat installation drawing for direction to seat installers is generated, cable lengths for wiring runs are calculated, and a load analysis for the seat configuration is generated demonstrating FAR compliance with Federal Aviation Regulations (FAR).

### BRIEF DESCRIPTION OF THE DRAWINGS

The preferred and alternative embodiments of the present invention are described in detail below with reference to the following drawings.

FIG. 1 shows an exemplary network for hosting the invention;

FIG. 2 shows an exemplary client computer on the network displayed in FIG. 1;

FIG. 3 is a flowchart setting forth an embodiment of a method of the present invention;

FIG. 4 is a logical chart showing input and selected outputs;

FIG. 5 is a LOPA diagram contained in CATIA;

FIG. 6 is a screen shot of extraction of the CATIA LOPA;

FIG. 7 is a diagram of a JAVA-based interface for viewing extracted models;

FIG. 8 is a diagram of a graphic representation of an extracted model and method for inputting data;

FIG. 9 is a representation of a three-dimensional model generated from one of the stored extracted models and augment data; and

FIG. 10 is a generated drawing showing placement of the seats as installed.

### DETAILED DESCRIPTION OF THE INVENTION

By way of overview, a method for generating three-dimension models and extracting data therefrom are provided. According to an exemplary embodiment of the present invention, a layout for interior configuration is received and critical dimensions are extracted from the interior configuration for the placement of seats. Seat dimensions for each of the several seat part numbers augment the extracted critical dimensions from the interior configurations. Assignment of part numbers to an appropriate location within the configuration enables generation of a three-dimensional solid model for testing in accord with known rules defining interference. Additionally, a seat installation drawing for direction to seat installers is generated, cable lengths for wiring runs are calculated, and a load analysis for the seat configuration is generated demonstrating FAR compliance.

It will be appreciated that a suitable host environment for the present invention may also be practiced in distributed computing environments where tasks are performed by remote processing devices that are linked through a communications network. In a distributed computing environment, program modules may be located in both local and remote memory storage devices. Execution of the program modules may occur locally in a stand-alone manner or remotely in a client/server manner. Examples of such distributed computing environments include local area networks of an office, enterprise-wide computer networks, and the Internet.

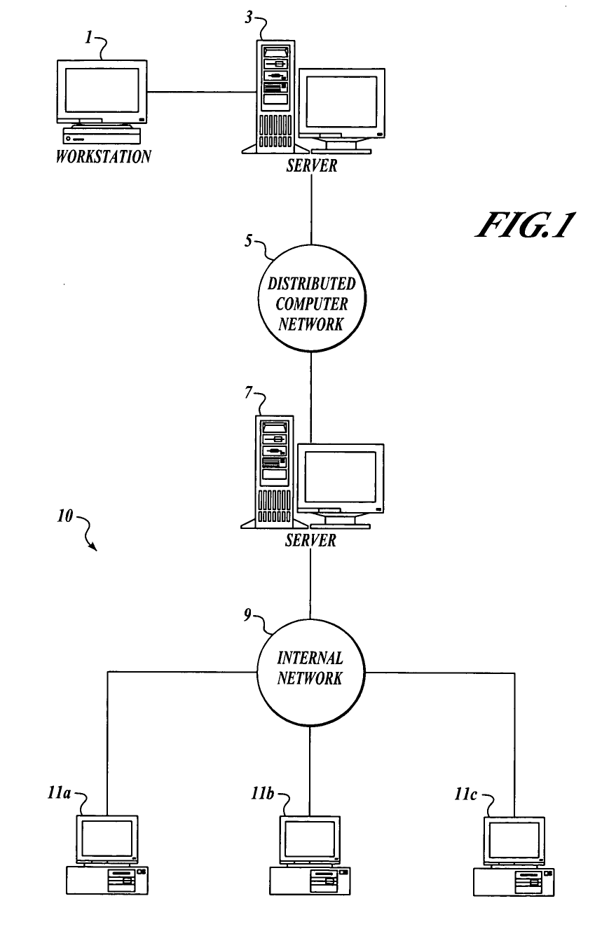

FIG. 1 illustrates a typical client-server environment 10 in which an exemplary embodiment of the present invention operates. A computer system or client 1, such as a conventional personal computer or any device operable to communicate over a network, is connected to an Internet server computer 3 (“server”). The server 3 is generally provided by an Internet service provider (ISP), which provides Internet access for a typical Internet user. The server 3 is connected to a distributed computer network 5, such as the Internet or a wide-area network (“WAN”), and enables the client 1 to communicate via the distributed computer network 5.

The client 1 communicates via the combination of the server 3 and the distributed computer network 5 to a server 7, such as a communication or an e-mail server. In an exemplary embodiment, servers 3 and 7 support e-mail services, contain a message store for holding messages until delivery, and contain a translation facility or gateway for allowing users having different e-mail programs to exchange mail. The server 7 is connected to an internal network 9, such as a local-area network (“LAN”) and enables the client 1 to communicate with the clients 11a, 11b, and 11c via the internal network 9.

The clients 11a, 11b, and 11c are not only able to respond to a communication from the client 1, but are also able to initiate communication with the client 1. The clients 11a, 11b, and 11c can send information via the internal network 9 to the server 7. The server 7, in turn, forwards the information to the client 1 via the distributed computer network 5. The information is retrieved by the server 3 and can be forwarded to the client 1, when requested by the client 1.

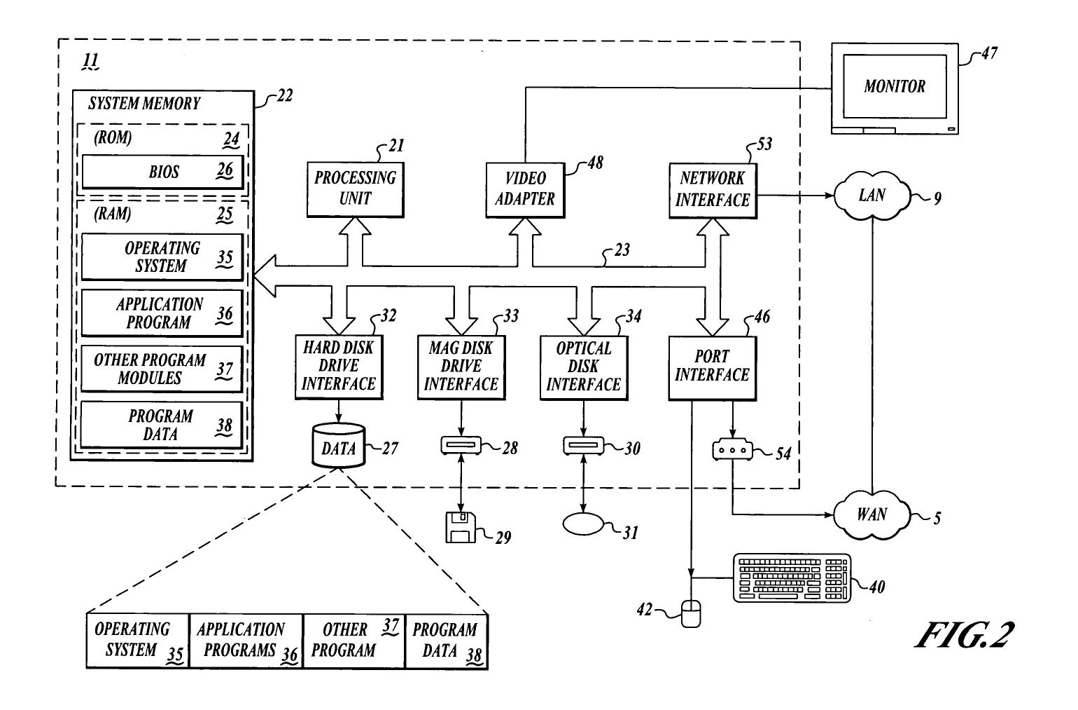

With reference to FIG. 2, an exemplary system for implementing the invention includes a conventional personal computer 11, which serves as a client. The client 11 may represent any or all of the clients 1, 11a, 11b, and 11c illustrated in FIG. 1. The client 11 includes a processing unit 21, a system memory 22, and a system bus 23 that couples the system memory to the processing unit 21. The system memory 22 includes read only memory (ROM) 24 and random access memory (RAM) 25. A basic input/output system 26 (BIOS), containing the basic routines that help to transfer information between elements within the client 11, such as during START-up, is stored in ROM 24. The client 11 further includes a hard disk drive 27, a magnetic disk drive 28, e.g., to read from or write to a removable disk 29, and an optical disk drive 30, e.g., for reading a CD-ROM disk 31 or to read from or write to other media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage for the client 11. Although the description of computer-readable media above refers to a hard disk, a removable magnetic disk and a CD-ROM disk, it will be appreciated by those skilled in the art that other types of media which are readable by a computer, such as magnetic cassettes, flash memory cards, digital video disks, Bernoulli cartridges, and the like, may also be used in the exemplary operating environment.

A number of program modules may be stored in the drives and RAM 25, including an operating system 35, one or more application programs, such as an e-mail program module 36, other program modules, such as a message manager program module 37, a local message store 38, and a database 39 for supporting e-mail applications. A user may enter commands and information into the client 11 through a keyboard 40 and pointing device, such as a mouse 42. Other input devices (not shown) may include a pen, touch-operated device, microphone, joystick, game pad, satellite dish, scanner, or the like. These and other input devices are often connected to the processing unit 21 through a port interface 46 that is coupled to the system bus, but may be connected by other interfaces, such as a serial port, game port or a universal serial bus (USB). A monitor 47 or other type of display device is also connected to the system bus 23 via an interface, such as a video adapter 48. In addition to the monitor, personal computers typically include other peripheral output devices (not shown), such as speakers or printers.

The client 11 operates typically in a networked environment using logical connections to one or more remote computers, such as a remote computer 49. The remote computer 49 may be an e-mail server (which includes one or more message stores), as described above in connection with FIG. 1, a file server (which includes one or more file stores), a router, a peer device or other common network node, and typically includes many or all of the elements described relative to the client 11. The logical connections depicted in FIG. 2 include the local area network (LAN) or the wide area network (WAN) 5. Such networking environments are commonplace in offices, enterprise-wide computer networks, intranets and the Internet.

When used in a LAN networking environment, the client 11 is connected to the LAN 9 through a network interface 53 or additionally through the WAN 5. When used in a WAN networking environment, the client 11 typically includes a modem 54 or other means for establishing communications over the WAN 5, such as the Internet. The modem 54, which may be internal or external, is connected to the system bus 23 via the serial port interface 46. In a networked environment, program modules depicted relative to the client 11, or portions thereof, may be stored in the remote memory storage device. It will be appreciated that the network connections shown are exemplary and other means of establishing a communications link between the computers may be used.

As is known, an Active Server Page (ASP) is suitably an uncompiled program that includes one or more sets of code that are processed on a server before the page is sent to the user. As is also known, an ASP is a feature of the Microsoft Internet Information Server (IIS). But, because the server-side script is just building a regular HTML page on the server then feeding it to the web browser, the resulting display can be delivered to almost any browser. While use of an ASP is a presently preferred method, the functionality of a page might be accomplished by including a script written in VBScript or JScript in an HTML file or by using ActiveX Data Objects (“ADOs”) program statements in the HTML file.

A presently preferred embodiment includes use of the server-side ASP rather than a client-side script, where either might work, because the server-side script will result in an easily displayable HTML page. It will be appreciated that client-side scripts (for example, with JavaScript) may not work as intended on older browsers or may result in performance degradation for loading the page. Sever-side script allows for greater control of variables in hardware or resident software that might otherwise affect the display of data stored on the network.

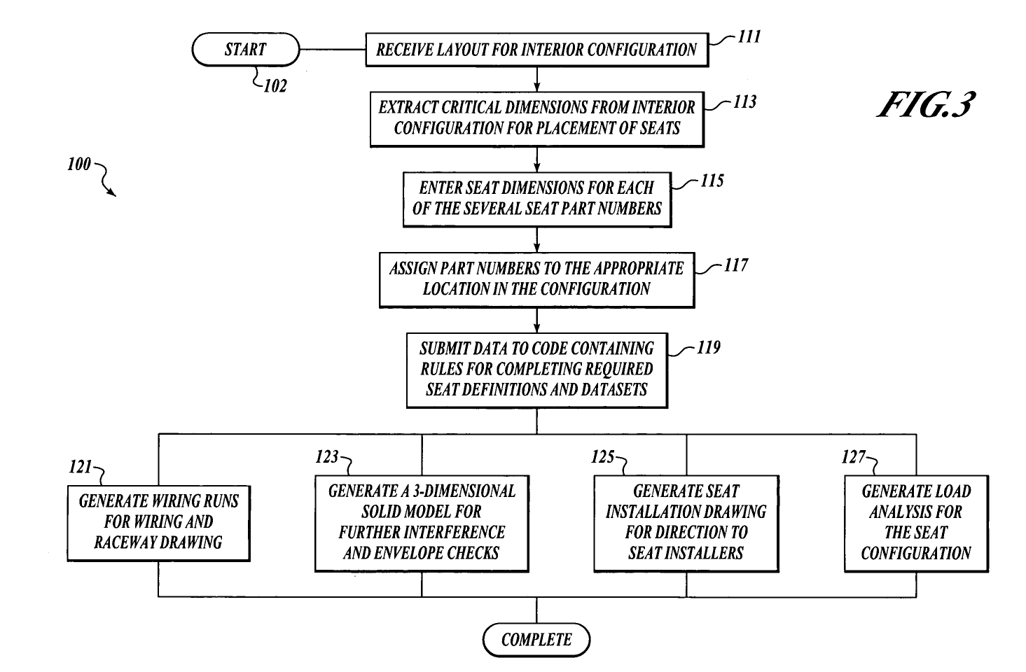

Referring now to FIG. 3, a routine 100 according to an exemplary embodiment of the present invention starts at a block 102. At a block 111, a customer order includes an interior configuration known as a LOPA. The LOPA is a plan view or two-dimensioned layout of personal appointments within the passenger cabin. Such appointments suitably include placement of lavatories, galleys, bulkheads, and, specifically, seats. The floor decking shown within the passenger cabin as laid out bares a number of tracks for fixing seat to the decking. While the placement of these tracks may be custom ordered, more often customers will utilize tracks in standardized positions. Seating manufacturers are aware of the placement of the tracks in the standardized configuration and manufacture seating according to the placement of the tracks. It is for this reason that the LOPA will often place seating units simply by reciting a part number and a station number. A station number represents a precise measurement of the seats positioned aft of the nose of the aircraft. The outline of the seat determines which of the seat tracks are involved.

The LOPA is generally represented in a two-dimensioned drawing in CATIA format. CATIA is an advanced computer-assisted modeling program often used for computer modeling of parts for production. Complex assemblies can be readily represented in a three-dimensioned computer generated space by means of CATIA coordinates. Other suitable modeling program formats include Unigraphix, AutoCAD, or any of a number of other such computer assisted drawing programs.

From the CATIA representation, or any other suitable representation, the computer extracts defining dimensions at a block 113. In one presently preferred embodiment, a computer program capable of interpreting CATIA, such as without limitation ICAD, can be programmed to perform the extraction. ICAD is not required, however. Any program capable of interpreting CATIA or other CAD representations suitably extract dimensions from those representations.

Once the dimensions are extracted, at a block 115, the dimensions are stored in association with the part numbers. In a presently preferred embodiment, a JAVA-enabled interface makes a graphic representation of the space approximating the layout of the space with seat templates. This graphic representation is stored in association with the order and allows defining dimensions of each seat to be entered according to its part number.

At a block 117, a one-to-one correspondence between the seat templates and part numbers is entered through the graphic interface described above. The critical dimensions corresponding to each part number are received from the seat manufacturer, often in the form of a paper drawing. By associating each of the graphic representations of the seats with a part number, each of the critical dimensions are then assigned in turn to the same graphic seat representation. Thus, in a rapid manner, all of the data required to produce a three-dimensional model of the seat is quickly entered into the computer.

At a block 119, the data to produce the three-dimensional model of the seat is applied to a set of rules for completing the seat definition and datasets. Non-limiting examples of rules are set forth as follows. For example, seats occupy a well-defined space on the decking of the passenger cabin. They have a forward and a rearward aspect; moreover, seat backs recant at predictable angles. Each of these rules are easy to define but may differ from one model of seat to another, and from one part number within a model line to another. These rules are incorporated in a presently preferred embodiment. Once each of these rules is defined, not only can the three-dimensional model be generated, but it can be tested for interferences.

As a result of the data entry, the computer can now perform any or all of four distinct engineering tasks. At a block 121, the computer generates wiring runs for each of the seat rows. In recent years, seats have become interactive client terminals for the presentation of in-flight entertainment. The cabling demands for each seat unit are great and the wiring harnesses to support such interactivity are large and complex. Calculating each cable length by hand may result in cable lengths that are too short due to calculation error. The computers can optimize these wiring runs. By knowing precisely where each seat meets the decking, wiring harness lengths can be calculated for the entire cabin.

At a block 123, the computer generates a three-dimensioned model of the seats within the passenger cabin space with sufficient detail to substitute for a mockup. In the industry, this seating model is known as an EPIC model and is used for checking interferences with any of the features of the cabin interior. A suitable computer program manipulates the model for interference testing. For instance, by means of the three-dimensional model, each of the seat backs can be tested to assure sufficient clearance for armrests or the interior hull of the cabin. This is especially important at the extreme aft end of the cabin where the hull assumes a predominantly conical shape. The radius of the cabin decreases as one moves aft and therefore it is possible for the seat back to interfere with the interior of the cabin.

In order to assure accurate placement of the seats in the cabin by installers, the computer generates a seat installation drawing at a block 125. The seat installation drawing shows the position of the seats and the part number corresponding to the seat for every seat in the passenger cabin. By giving the station number and showing its location on the various preinstalled tracks, the seat installation drawing locates each seat in the passenger cabin.

The Federal Aviation Administration currently requires that each seating unit be able to bear certain loads including a 9-G load. In order to satisfy that requirement, at a block 127, the loads the seat units exert, under 9-G acceleration, on fasteners affixed to the decking are calculated. These are compared to the to ratings for the fasteners to assure compliance with the appropriate FAR.

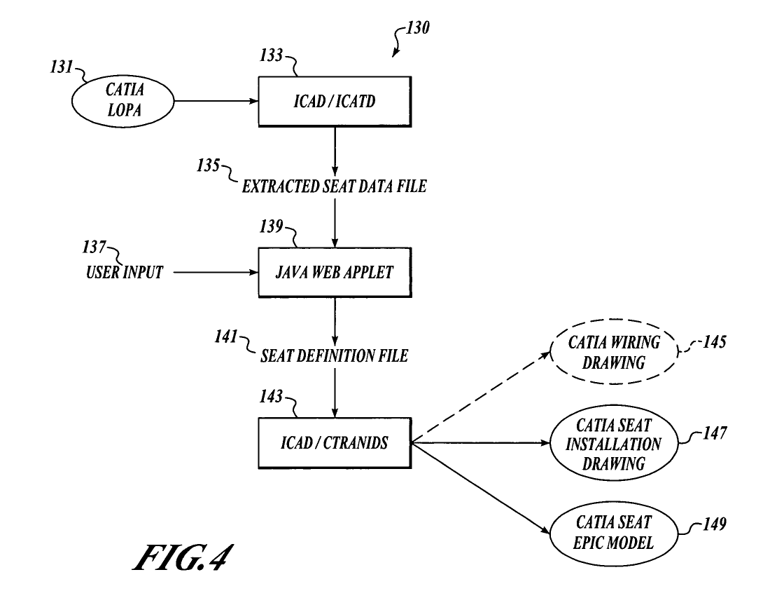

Referring now to FIG. 4, a presently preferred data flow diagram 130 shows flows of data used to generate a three-dimensioned model. Advantageously, due to the interactivity of the various components, the complexity of the problem yields to economies in the tasking.

The conventional format of a LOPA is in CATIA modeling. At a block 133, an ICAD software component readily extracts data from the CATIA model. At a balloon 131, data used to show placement of seats in the passenger cabin is used to generate an extracted seat data file 135. In one presently preferred embodiment, a web-based JAVA-applet 139 interacts with the user to input the dimensions of the various seats within the passenger cabin as defined by the commercial carrier.

The JAVA-web applet 139 provides a graphic and user-friendly interface for the entry of this information and by means of preprogrammed controls helps to avoid mistakes in data entry. Because of this joinder of seat specifications and the LOPA, a definition file 141 is provided to an ICAD component 143. Appropriately programmed, the ICAD component 143 produces the desired output that includes a CATIA wiring diagram 145, a CATIA seat installation drawing 147, and a CATIA seat EPIC model 149, as well as loading data.

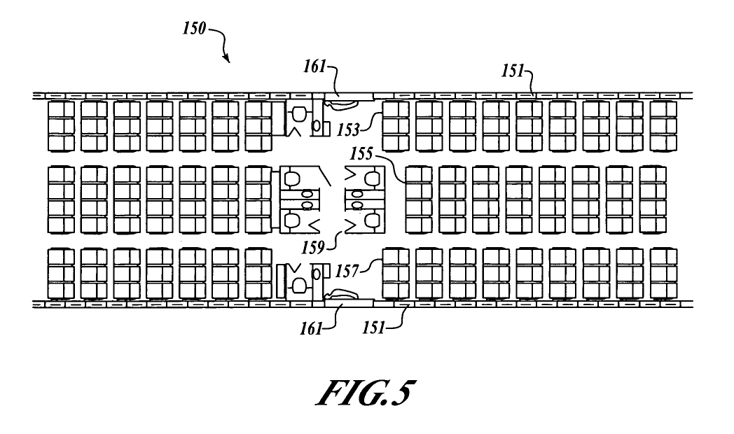

Referring now to FIG. 5, an exemplar LOPA is presented by the commercial carrier customer. This particular LOPA is a middle section defined at its left and right extremes by an interior hull 151 and its supporting architecture. Three distinct part numbers of a desired seat model are shown for rows 153, 155, and 157. As the middle row of seats is portrayed, no accommodation is suitably made for the interior of the hull because no interference is reasonably expected. Seat row 153 and seat row 157 each have an accommodation for the interior curvature of the hull. Reducing the area of the seat back where it might come in contact with the hull generally makes this accommodation. Additionally, because of the proximity of an exit 161, tray tables for seats in row 157 are suitably placed in the arm rests because no seat backs are readily available to carry the tray table. The LOPA includes several lavatories 159. Within a particular LOPA, it is common to have as many as 30 distinct seat part numbers with 15 to 18 part numbers dedicated to the coach compartment. Each of the part numbers may differ in one detail or another in order to accommodate placement within the cabin. Nonetheless, within the cabin, all of the seats suitably have coordinated upholstery, giving the passenger cabin the feel of a unified hull.

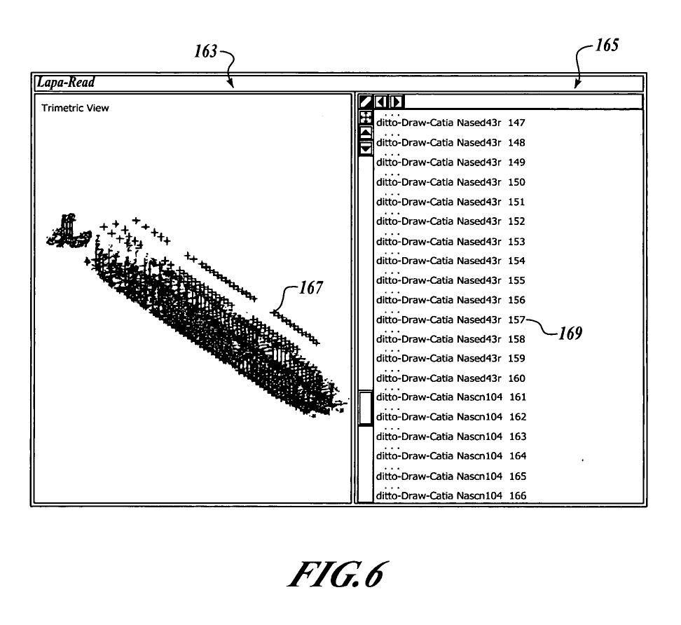

Referring now to FIG. 6, the ICAD component 133 (FIG. 4) “reads” the LOPA or the electronic data that comprises the LOPA (FIG. 5) and extracts the seat type and its precise location in a pane 163. The LOPA that was shown in plan view in FIG. 3 is now shown in trimetric view. The part numbers and location are extracted from the CATIA drawing in pane 165. Thus, for any set of attachment points 167, there exists a corresponding data extraction 169 representative of the seat, its part number, and its location in the cabin.

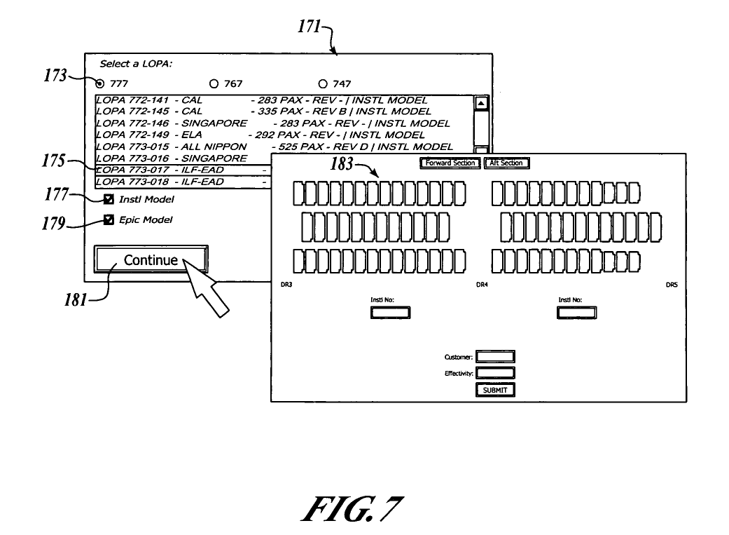

Once the LOPA is fully extracted and stored on the system, the user interacts with the data by means of the JAVA-web applet 139 (FIG. 4). FIG. 7 shows two of the screens 171 and 183 of the JAVA applet 139 (FIG. 4). The screen 171 shows a compilation of a number of LOPAs stored on the machine. By means of a radio button selector 173, the user has indicated a desire to view the orders for model 777. Scrolling down through the orders presented, the user selects at a highlighted box 175 the LOPA corresponding with order number 773-017-ILF-EAD. At a check box 177, the user has indicated a desire to generate an INSTL model. At a check box 179, the user also desires an EPIC model. The user then sends these selections back to the computer by means of activating a “clickable” box 181. As a result, the user is presented with the graphic representation of the passenger cabin 183.

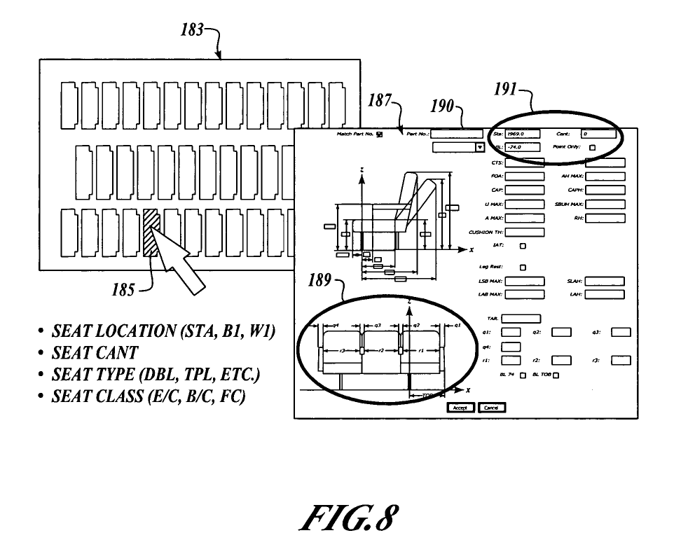

Referring now to FIG. 8, a user selects a particular seat row 185 and “clicking” on it; the user indicates a desire to see the specific dimension sheet related to that seat row. To enable that function, the interface generates a data sheet pane 187 for the particular seat row.

While the graphic representation does not endeavor to exactly place the seats in the passenger space, the computer stores placement of the seats in series of data points indicated in a balloon 191. These data points are provided and are also variable by the user. The user may then enter the part number at a space 190 and, if the appropriate dimensions are stored on the computer, the computer will immediately auto fill each of the dimensions. If the computer does not have a particular part number prestored, the user now may indicate each of the values appropriate in the boxes set forth. To assist the user and to prevent the introduction of errors, the computer generates a graphic representation 189 of the seat according to the part number.

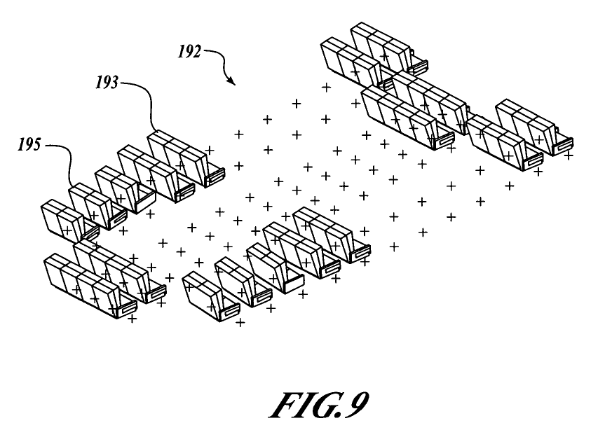

When the seat definition file is complete, the computer will then generate for the user an EPIC model as shown in FIG. 9. The utility of distinct part numbers is demonstrated by the need for placement of both three-seat-rows 193 and two-seat-rows 195 along a single aisle. Also generated at the user's request is an installers' diagram.

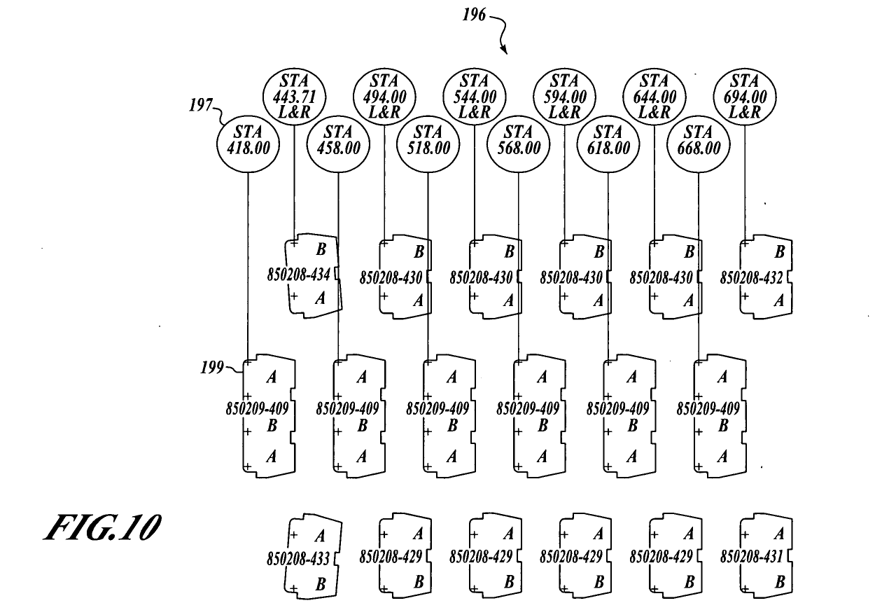

As shown in FIG. 10, the installers' diagram 196 is a clear and uncluttered way of presenting to the installers the information necessary to replicate the cabin that has been previously computer-modeled. Station numbers representative of the distance aft in the cabin are placed in balloons. A seat template 199 shows the four attachment points in the rails already existing in the decking (not shown). A part number is also provided as well as alpha/numeric indicators to portray the color of the seat.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for generating computer-based models of seats in a passenger compartment from a two-dimensional drawing, the method comprising:
receiving a two-dimensional lay-out drawing;
extracting dimensions for the placement of seats from the received two-dimensional drawing;
assigning part numbers to the placed seats; and
generating a model of the seats placed in a three-dimensioned representation of the passenger cabin based upon the extracted dimensions and assigned part numbers.

2. The method of claim 1, wherein generating of the model includes generating cable lengths for wiring runs.

3. The method of claim 1, wherein generating of the model includes generating seat loads.

4. The method of claim 1, wherein generating of the model includes generating a two-dimensional seat installation drawing.

5. The method of claim 1, wherein assigning part numbers includes referring to a data table including criteria associated with the part number.

6. The method of claim 5, wherein the criteria include dimensions of the seat.

7. The method of claim 5, wherein the criteria include a three-dimensional representation of the seat.

8. The method of claim 5, wherein the criteria include the recant paths of the seat backs.

9. A computer program residing on a readable memory medium for generating computer-based models of seats in a passenger compartment from a two-dimensional drawing, the computer program comprising:
a first computer program code means configured for receiving a lay-out drawing;
a second computer program code means configured for extracting dimensions for placement of the seats from the received drawing;
a third computer program code means configured for assigning part numbers to the placed seats; and
a fourth computer program code means configured for generating a model of the seats placed in a three-dimensional representation of the passenger cabin based upon the extracted dimensions and assigned part numbers.

10. The computer program of claim 9, wherein the fourth computer program code means includes a fifth computer program code means for generating cable lengths for wiring runs.

11. The computer program of claim 9, wherein the fourth computer program code means includes a sixth computer program code means configured for generating seat loads.

12. The computer program of claim 9, wherein the fourth computer program code means includes a seventh computer program code means configured for generating a two-dimensional seat installation drawing.

13. The computer program of claim 9, wherein the third computer program code means includes a sixth computer program code means configured to reference a data table, the data table including criteria associated with the part number.

14. The computer program of claim 15, wherein the criteria include dimensions of the seat.

15. The computer program of claim 15, wherein the criteria include a three-dimensional representation of the seat.

16. The computer program of claim 15, wherein the criteria include recant paths of the seat backs.

17. The computer program of claim 9, wherein the fist, second, third, and fourth computer program code means are stored on a computer readable medium accessible over a network on an active service page.

18. A system for generating computer-based models of seats in a passenger compartment from a two-dimensional drawing, the system comprising:
a first component means for receiving a lay-out drawing;
a second component means for extracting dimensions for the placement of seats from the received drawing;
a third component means for assigning part numbers to the placed seats; and
a fourth component means for generating a model of the placed seats in a three-dimensioned representation of a passenger cabin based upon the extracted dimensions and assigned part numbers.

19. The system of claim 18, wherein the fourth component means includes a fifth component means for generating cable lengths for wiring runs.

20. The system of claim 18, wherein the fourth component means includes a sixth component means for generating seat loads.

21. The system of claim 18, wherein the fourth component means includes a seventh component means for generating a two-dimensional seat installation drawing.

22. The system of claim 18, wherein the third component means includes a sixth component means for referencing a data table, the data table including criteria associated with the part number.

23. The system of claim 18, wherein the criteria include dimensions of the seat.

24. The system of claim 18, wherein the criteria include a three-dimensional representation of the seat.

25. The system of claim 18, wherein the criteria include the recant paths of the seat backs.

26. The system of claim 18, wherein the fist, second, third, and fourth component means include computer program code stored on a computer readable medium accessible over a network on an active service page.
